(19) United States
(12) Patent Application Publication
(10) Pub. No.: US 2004/0181425 A1
(43) Pub. Date: Sep. 16, 2004

(54) Change Management

(76) Inventors: Sven Schwerin-Wenzel, Dielheim (DE); Eric Wood, Menlo Oaks, CA (US); Nir Kol, Sunnyvale, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/750,406

(22) Filed: Dec. 31, 2003

Related U.S. Application Data
(60) Provisional application No. 60/455,087, filed on Mar. 14, 2003.

(51) Int. Cl. G06F 17/60

(52) U.S. Cl. 705/1

(57) ABSTRACT

Systems and techniques relating to software for enterprise change, in particular to restructuring processes and tools for one or more organizations. In one general implementation, the technique includes the generation of a single logical information system across one or more information systems of at least two enterprises, wherein the enterprises are combined, and the single logical information system is used to execute restructuring activities. The logical information system facilitates restructuring-related issue management.

### CROSS REFERENCE TO RELATED APPLICATIONS

This application claims priority to U.S. Provisional Application entitled “ENTERPRISE CHANGE PLANNING AND EXECUTION,” filed on Mar. 14, 2003, application Ser. No. 60/455,087.

### FIELD OF THE INVENTION

The present invention relates to data processing by digital computer, and more particularly to a change management system.

### BACKGROUND

During an organizational restructuring, such as a merger, acquisition, corporate change or spin-off, an organization can need to determine how to effectively serve current customers. In order to obtain one or more goals, organizations can desire to manage one or more integration issues related to the restructuring. Moreover, organizations can want to assign one or more groups to monitor the progress of integration.

### SUMMARY

The present application describes systems, methods and software for enterprise change, such as corporate restructurings, for one or more organizations.

In an aspect, the invention features a method including providing a single logical physically distributed information system across one or more information systems of at least two enterprises, the enterprises can be being combined, and providing a user interface to access the single logical physically distributed information system to manage one or more restructuring-related issues, the user interface can be adapted to manage one or more deliverables associated with a restructuring.

In embodiments, the method can include providing a user interface to integrate restructuring-related projects and resources for at least one enterprise, providing a user interface to implement restructuring-related projects and resources for at least one enterprise, and providing a user interface to manage training, planning, and communication activities. A user interface can be provided to use the single logical physically distributed information system to execute at least one of pre-restructuring and post-restructuring activities, the post-restructuring activities including a post-restructuring assessment and a measurement of one or more achieved synergies. One or more user interfaces can be adapted to a role of the user and a phase of the restructuring, a security of the one or more user interfaces being related to the role of the user and the phase of the restructuring, the role of the user including an executive role.

In another aspect, the invention features a system for planning a merger of at least two organizations, the system including a software product, wherein the software product can include a module adapted to allow a user to manage one or more merger-related projects for at least one of the organizations, wherein the module can include one or more sub-modules adapted to allow a user to address merger-related issues wherein the sub-modules comprise at least one of an executive cockpit sub-module, a training management sub-module, a deliverables management sub-module, a project planning sub-module, and a communications management sub-module, wherein the deliverables management sub-module can include a deliverable room sub-module and a deliverable tracker sub-module, wherein the executive cockpit sub-module can be adapted to provide a view of a merger integration progress for one or more executive stakeholders.

In embodiments, the training management sub-module serves as a repository to request, schedule, and monitor an execution of one or more training sessions, and the training management sub-module further provides a platform to facilitate one or more training processes. The training management sub-module can include at least one of a training class repository, a master training scheduler, an electronic mailing service for training invitations, and an archive of on-line training, and the master training scheduler can include at least one of a department-specific scheduling service, a department-specific planning service, a role-specific scheduling service, and a role-specific scheduling service.

The training management sub-module can be adapted to track a completion of training for one or more stakeholders, training topics, and organizational locations, and the training management sub-module can be further adapted to report a completion of training for one or more stakeholders, training topics, and organizational locations to a user.

In another aspect, the invention includes a system for managing a merger of at least two organizations, the system including a portal, an object modeling tool, and a computer module adapted to allow a user to monitor one or more tasks associated with a synergy achievement, the computer module including a deliverable room.

In embodiments, the deliverable room can include a sub-deliverable room, wherein the sub-deliverable room can include one or more characteristics from the deliverable room, wherein the one or more characteristics comprise security permissions, and the computer module can be further adapted to generate and assign one or more tasks associated with the synergy achievement.

In another aspect, the invention features a system for managing a merger of at least two organizations, the system including a computer product including a deliverable room adapted for one or more merger stakeholder users, wherein the one or more stakeholder users comprise an executive of at least one of the organizations.

In embodiments, the computer product can include one or more interfaces adapted to present merger-related information including, at least one of a team roster, a task list, a shared folder, a meeting scheduler, a note from a meeting, an issue list, a decision list, and a status. The deliverable room can include a hierarchal parent room of one or more sub-deliverable rooms, wherein the deliverable room can include a reference model, and the reference module can include pre-populated data. The deliverable room further can include at least one of a methodology, a help tool, and a set of contextual tools adapted for a specific deliverable, wherein the specific deliverable can include a realignment of compensation for employees.

In another aspect, the invention features a system for managing a merger of at least two organizations, the system including a user interface adapted to allow a user to access, plan, and manage the merger, the interface presenting one or more performance indicators of an entity within one of the organizations.

In embodiments, the interface further presents one or more merger issues in a decision box.

In another aspect, the invention features a system for managing a merger of at least two organizations, the system including a collaborative calendar interface, the calendar interface adapted to allow stakeholders to view merger-related events and to facilitate training management.

In embodiments, the collaborative calendar interface facilitates one or more rollout trainings and one or more scheduling of one or more services for the stakeholders, wherein the calendar interface can include information relating to at least one of a stakeholder role and a merger group, wherein the calendar interface further adapted to allow an exchange of information with an external calendar tool.

In another aspect, the invention features a computer system for managing a merger of at least two organizations, the computer system including merger-related information and a user interface adapted to present one or more merger deliverables, wherein the user interface can include a panel presenting one or more requested deliverables and one or more deliverables assigned to an interface user.

In embodiments, the panel further presents at least one of a targeted merger task force, an initiating deliverable contact person, a deadline, and a status, the one or more merger deliverables including one or more merger sub-deliverables.

In another aspect, the invention features a system for managing a merger of at least two organizations, the system including a computer module, the computer module including a merger deliverables tracker tool and a user interface adapted to present one or more merger-related deliverables tracked with the tracker tool.

In embodiments, the user interface can be adapted to allow a stakeholder to select a view of one or more lists of deliverables by at least one of a meeting date and a task force, the interface adapted to present a deliverables tracker reference session link. The view of one or more lists can include a meeting date, a time, a milestone, a location, and a deliverable information, the deliverable information including a name, a task force, a requester, an assignee, and a status.

In another aspect, the invention features a system including restructuring-related interfaces for a restructuring of at least two organizations, the restructuring-related interfaces including one or more restructuring-related issues, user interface components adapted to interact with the restructuring-related interfaces, and a layer of application logic services, the layer interacting with the restructuring-related interfaces, the application logic services related to the restructuring.

### BRIEF DESCRIPTION OF THE DRAWINGS

These and other aspects will now be described in detail with reference to the following drawings.

FIG. 1 is a block diagram.

FIG. 2 is a flow diagram.

FIG. 3 is a block diagram.

FIG. 4 is a flow diagram.

FIG. 5 is a block diagram.

FIG. 6 is a tool interface.

FIG. 7 is a collaborative calendar interface.

FIG. 8 is an interface.

FIG. 9 is an interface.

FIG. 10 is an interface.

FIG. 11 is an interface.

FIG. 11A is an interface.

FIG. 12 is a home page interface.

FIG. 13 is an interface.

FIG. 14 is an interface.

FIG. 15 is a flow chart.

FIG. 16 is an interface.

FIG. 17 is a template.

FIG. 18 is a block diagram.

FIG. 19 is a block diagram.

FIG. 20 is an interface.

FIG. 21 is a schedule interface.

FIG. 22 is a proposal interface.

FIG. 23 is an interface.

FIG. 24 is an interface.

FIG. 25 is an interface.

Like reference symbols in the various drawings indicate like elements.

### DETAILED DESCRIPTION

The systems and techniques described here relate to software for organizations in a corporate restructuring such is in a merger and acquisition (M&A) environment. In particular, the software described herein can aid in the integration and implementation of restructuring-related projects and resources for one or more restructuring enterprises or organizations. The disclosed software can also aid in the management of training, planning, and communication activities of one or more enterprises during a restructuring process, such as in a merger and acquisition (M&A) process, corporate spin-offs, department mergers/splits, and so forth.

The disclosed software can include various tasks, techniques, and interfaces for a restructuring organization to assess, manage, and adjust integration issues. The software can allow restructuring members, such as executives, and merger teams, such as steering committees and task forces, to monitor the progress of the restructuring integration. The software can manage restructuring-related communications and track and manage one or more deliverables. Moreover, the disclosed software can provide a virtual project room for executives, in which the software can provide a common collaborative environment for restructuring members responsible for one or more deliverables.

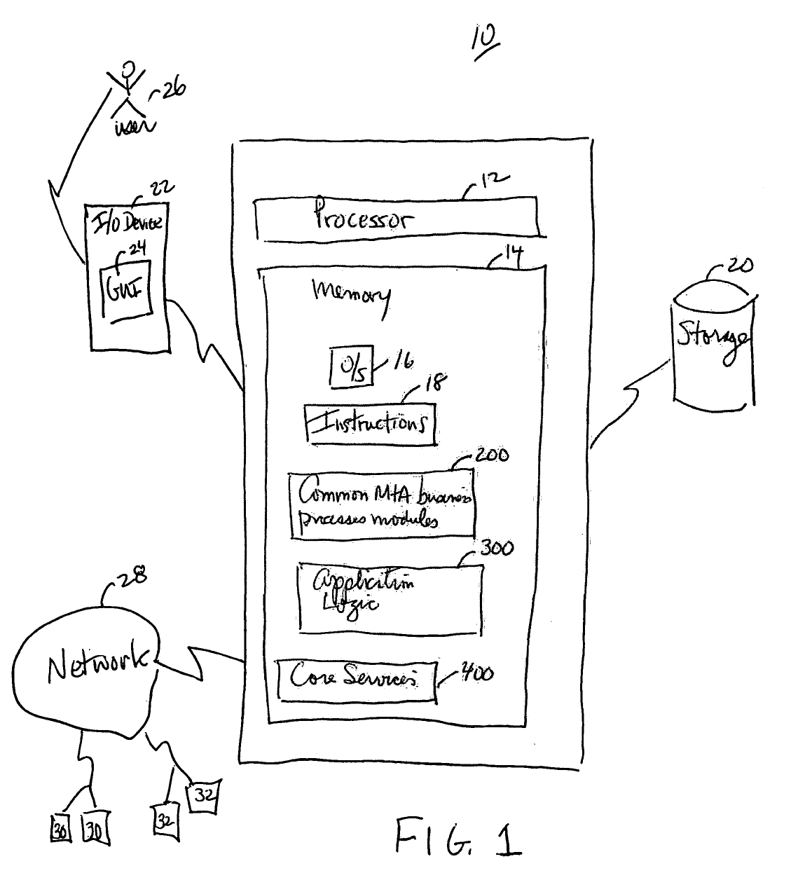

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of an architecture, described below.

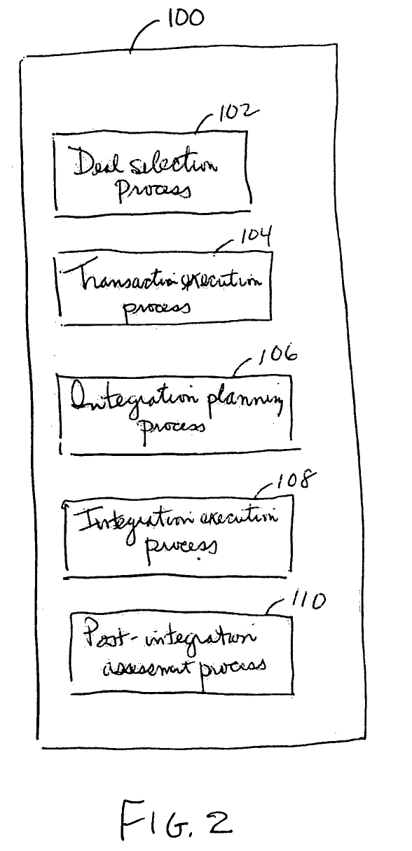

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly. The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

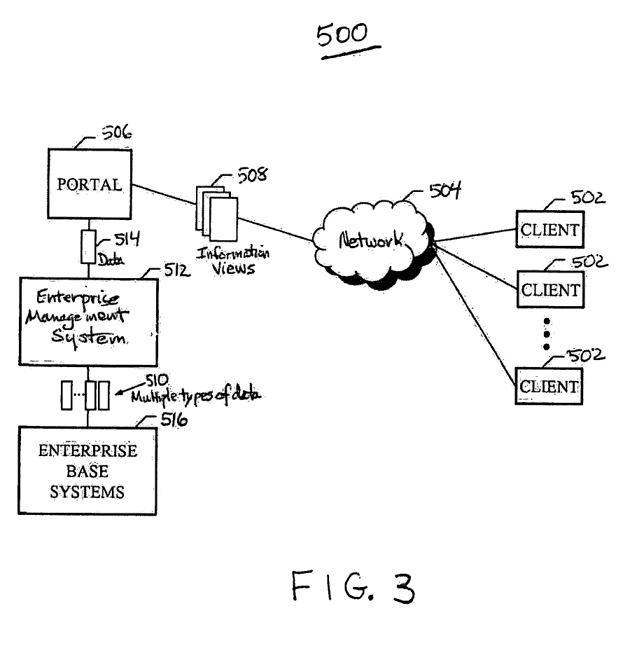

As shown in FIG. 3, the restructuring integration process 100, common restructuring business processes modules 200, application logic 300, and core framework of services 400 are designed to conform to an architecture 500 designed to a platform 600 that represents a single logical physically distributed information system representing multiple enterprise information systems of organizations. The architecture 500/platform 600 insure consistency of data exchange between system 10 and source systems 30, 32, and a separation of source systems 30, 32, when appropriate during phases of the restructuring integration process 100.

The single logical physically distributed information system architecture 500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508. The portal 506 receives requests from the clients 502 and generates information views (iViews) 510, such as web pages, in response. In embodiments, the portal 506 implements a user roles-based system to personalize a common interface and the iViews 510 for a user of one of the clients 502. The user can have one or more associated roles that allow personalized tailoring of a presented interface through the iViews 510.

The portal 506 communicates with an enterprise management system 512 that consolidates multiple application services.

The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth. The system 512 communicates with enterprise base systems 516 to obtain multiple types of enterprise base system data 518.

The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as exchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” are two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on.

Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyongoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

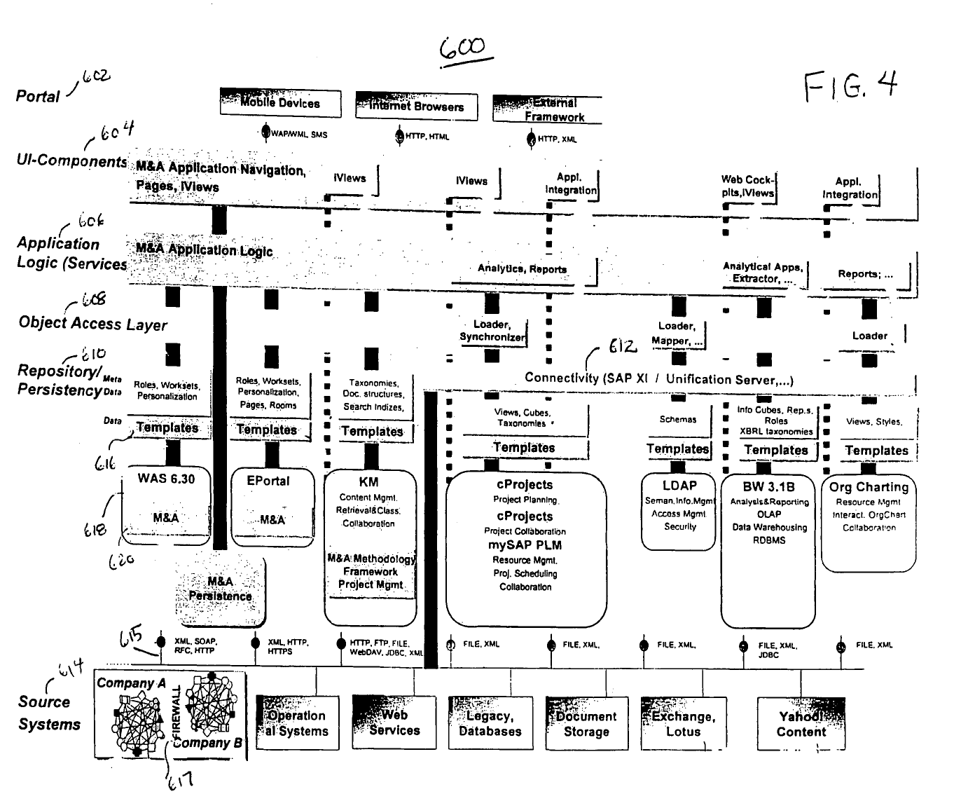

As shown in FIG. 4, a platform 600 that supports the architecture 500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as SOAP, request for comments (RPC), or TCP/IP. The source systems of one organization can interact with the source systems of another organization through a firewall 617.

The base system connectors 615 can include a enterprise connector (BC) interface, Internet communication manager/Internet communications framework (ICM/ICF), an encapsulated postscript (EPS) interface and/or other interfaces that provide remote function call (RFC) capability.

The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/repository layer 610 and the base systems 516/614. The persistence/repository layer 610 decouples application development from the underlying base systems 516/614.

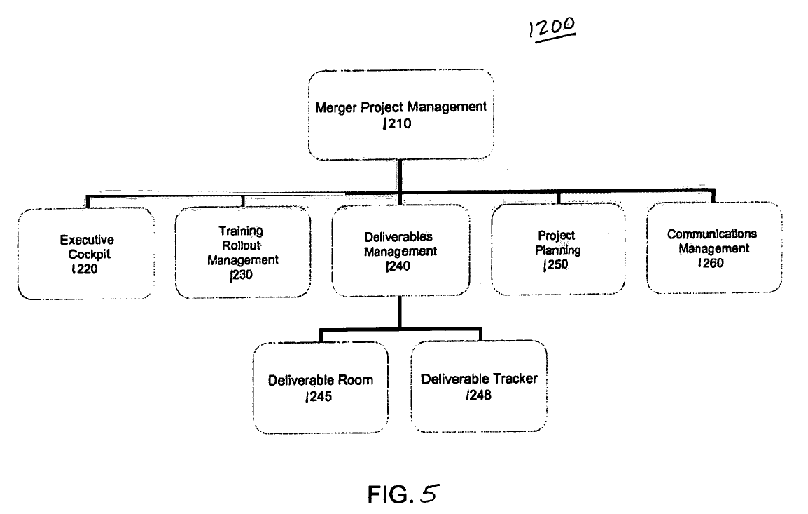

As shown in FIG. 5, the common restructuring business processes modules 200, in the context of an exemplary merger and acquisition, include a merger project management module 1210. The module 1210 can include one or more sub-modules to address a number of merger integration issues. Such sub-modules can include an executive cockpit sub-module 1220, a training rollout management sub-module 1230, a deliverables management sub-module 1240, a project planning sub-module 1250, and a communications management sub-module 1260. The deliverables management sub-module 1240 can include sub-modules for a deliverable room module 1245 and a deliverable tracker module 1248.

The executive cockpit sub-module 1220 contains a high-level view of an integration project at a point in time. The cockpit sub-module 1220 allows merger executives to monitor the progress of a merger integration in relation to one or more goals.

The training rollout management sub-module 1230 serves as a repository or platform to request, schedule, and monitor execution of training sessions or processes. In one embodiment, the training rollout management sub-module 1230 provides a platform to facilitate one or more training processes. The training rollout management sub-module 1230 may not itself provide training capabilities. The training rollout management sub-module 1230 can provide one or more categorized lists of training sessions desired by various stakeholders. The training rollout management sub-module 1230 provides a repository for training classes and a master training scheduler. The master training scheduler provides department-specific or role-specific scheduling and planning services to train stakeholders. The training rollout management sub-module 1230 provides electronic mailing (e.g., email) services for training invitations and corresponding registration tracking. The training rollout management sub-module 1230 can track and report completion of training for various stakeholders, training topics, and organizational locations.

The deliverables management sub-module 1240 allows strategy and management users to generate, assign, and monitor tasks associated with achieving one or more synergies. The achieved synergies can be in a specific “virtual” team room environment, also referred to as a “deliverable room”. Users managing integration projects in each of the deliverable rooms are able to generate and manage a number of sub-deliverable projects under an umbrella of a larger deliverable room project. Sub-deliverable rooms inherit characteristics from their parent deliverable room, and the sub-deliverable rooms have features that are integrated with other issues, decisions, document folders and tasks. Some inherited characteristics include security permissions.

A deliverable room can be a virtual project room for executives. The deliverable room can include a team roster, a task list, a shared folder, and a meetings scheduler. The deliverable room can also include one or more notes from meetings, issue lists, decision lists, and statuses. The deliverable room can depend on a project in a master plan, in which the master plan involves other deliverable rooms. A deliverable room can be a hierarchal parent room of one or more sub-deliverable rooms.

The deliverable room can be based on an existing reference model in which the room is pre-populated with data such as folders and issues. A predefined deliverable room is predefined for a specific restructuring scenario, such as planning a strategic objective. The predefined rooms include methodologies, help tools, and a set of contextual tools to be used for a specific deliverable, such as a realignment of compensation for employees.

The deliverables management sub-module 1240 also includes a deliverable tracker sub-module 1248. The deliverable tracker sub-module 1248 refers to a monitoring tool for an integration management task force to assign deliverables, schedule milestones, and check the status of other task forces.

When a deliverable is assigned to a merger group or task force, it can first be assigned to a task force leader. The task force leader can reject, accept, or re-assign the deliverable. Each task force can have a sponsor in a steering committee to receive the deliverable and task assignments and requests.

The project-planning sub-module 1250 provides one or more interfaces to enable basic project management capabilities, such as managing a timeline of a restructuring project, or setting milestone meetings, deliverables, due dates, owners, and progress tracking.

The communications management sub-module 1260 allows a communications task force to plan, execute, and monitor restructuring-related communication throughout the restructuring process 100. The communications management sub-module 1260 reduces the risk of restructuring failures due to unclear vision, strategy, rumors, and cultural fit issues. Other stakeholders use the communications management sub-module 1260 and search for information. Restructuring organizations can initiate communications and communicate restructuring-related ideas and requirements. A steering committee uses polls and surveys for monitoring restructuring progress and success. The communications management sub-module 1260 includes an archive for restructuring-related communications.

The communications management sub-module 1260 manages a complete life cycle of various aspects of communications during a restructuring. Some of the aspects include communication campaigns, information updates, events, and monitoring. The communications management sub-module 1260 informs stakeholders of restructuring events, statuses, rollouts, follow-ups and different phases of the restructuring. The communications management sub-module 260 provides a variety of communication actions such as sending requests for approval, updating restructuring progress, and loading information from a template. The communications management sub-module 1260 helps inform stakeholders of new campaigns, new events, news items, polls, surveys, and frequently asked questions (FAQs). The communications management sub-module 1260 also helps inform stakeholders of question and answers (Q&As), new assignments, schedule reminders, language translation requests, new reports, and previous communications.

Each communication includes one or more features, such as an objective, a short description, an issue, a policy, an announcement, an initiative, an attachment, an owner, a due date, and a target audience. Moreover, each communication includes a media selection, a budget, a priority, a status, and a restructuring measurement over a time period.

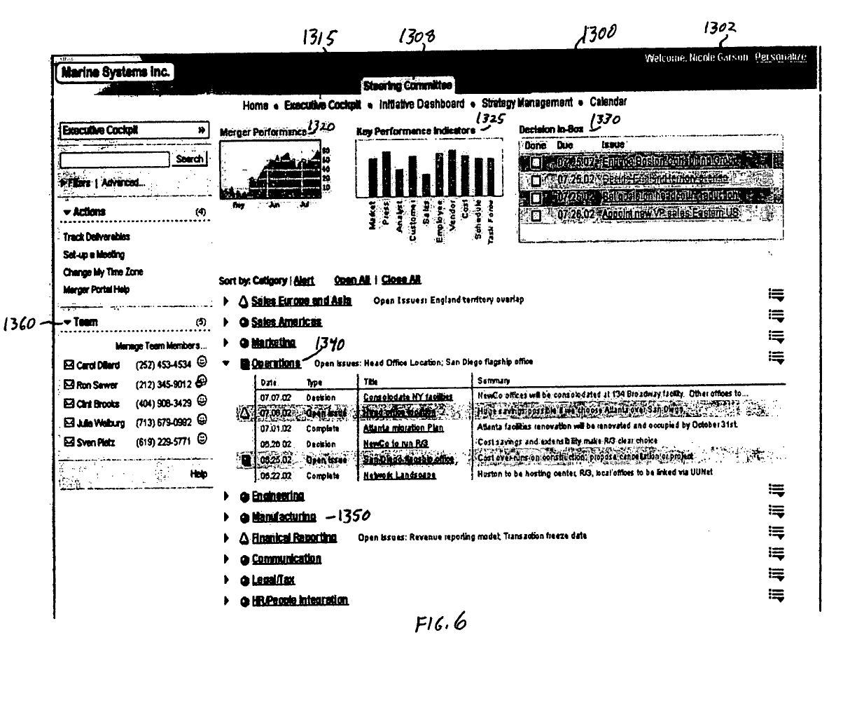

FIG. 6 illustrates a tool interface 1300 for a stakeholder 1302 in a restructuring steering committee. The steering committee can have an interface tab 1308 that presents a menu of views, including a presented view of an “executive cockpit” 1315. The executive cockpit view 1315 is also referred to as a “Control Center” page or dashboard. The executive cockpit view 1315 allows executive board stakeholders 1302 to access, plan, and manage various aspects of a restructuring. The interface 1300 can provide a restructuring performance chart 1320 and key performance indicators 1325. The interface 1300 presents restructuring issues in a decision box 330. Restructuring issues can also be presented by type or category. For example, the stakeholder 1302 can view issues in a manufacturing division 350 or in an operations department 340. The interface 1300 allows the stakeholder 1302 to contact and manage other stakeholders 1360.

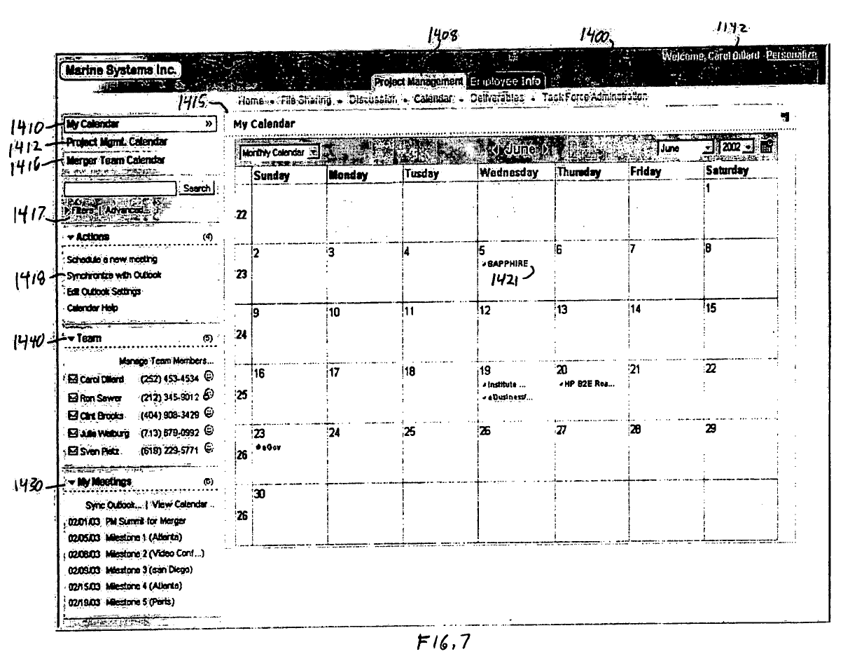

FIG. 7 shows an example of a collaborative calendar interface 1400 for a stakeholder 1142 in a restructuring. The collaborative calendar interface 1400 has an event 1421 that can be scheduled by user 1142 or a member of a team 1440. The calendar 1415 serves as a master calendar to allow stakeholders to have a single, common view of restructuring-related events. The calendar 1415 synchronizes and exchanges information with external calendar tools 1418, such as a calendar tool in Outlook® by Microsoft Corporation. The calendar interface 1400 facilitates rollout trainings and training rollout management. The interface 1400 facilitates a scheduling and planning of services for restructuring members who fit a particular restructuring role or group. The user 1142 collaborates with a calendar 1412 of another restructuring group. The user 1142 can access a personal calendar 1410 to incorporate all of the events from each calendar in which the user 1142 may have access. The personal calendar also can store and present personal user events and meetings 1430. The calendar interface 1415 presents various levels of user authorization (not shown) and filtering capabilities 417.

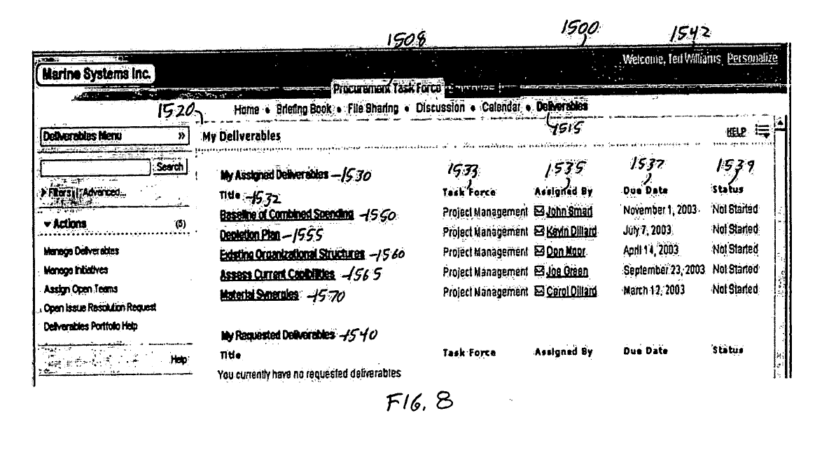

FIG. 8 shows an exemplary interface 1500 with a procurement task force tab 1508 that has a menu of views including a deliverables view 1515. The interface 1500 includes a panel 1520 with personalized assigned deliverables 1530 and requested deliverables 1540. Some deliverable topics 1532 include a baseline of combined spending 1550, a depletion plan 1555, an organizational structure 1560, a view of current capabilities 1565, and a view of material synergies 1570. In addition to presenting deliverable topics 1532, the panel 1520 presents a targeted restructuring task force 1533, an initiating deliverable contact person 1535, a deadline 1537, and a status 1539. A user 1542 can select a deliverable, such as material synergies 1570, to access another view of deliverable information.

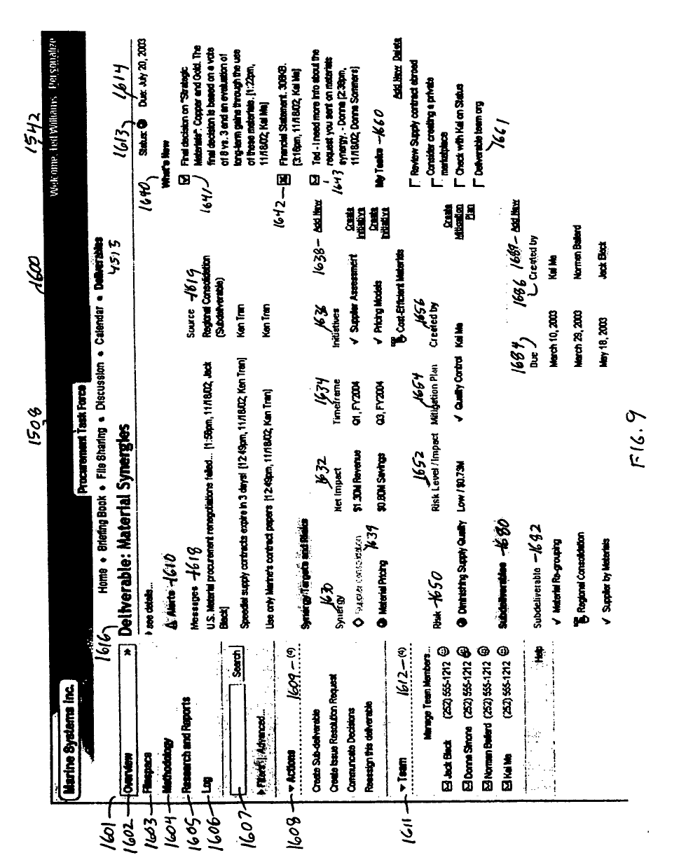

FIG. 9 shows an exemplary interface 1600 with a procurement task force tab 1508 that has a menu of views including a deliverables view 1515. A user 1542 views a material synergies panel 1616 with an alerts section 1610, a synergy targets and risks section 1620, and a sub-deliverables section 1680. In the alert section 1610, the user 1542 can inspect restructuring-related messages 1618, along with a message source 1619. The user 1542 can view a net impact 1632 of a synergy 1630 supporting an initiative 1636 in a given time frame 1634. The user 1542 can also evaluate a risk level impact 1652 of a restructuring risk 1650 from a plan 1654 generated by a stakeholder listed in column 1656. A sub-deliverables section 1680 presents a group of sub-deliverables 1682 with corresponding deadlines 1684 and owners 1686. The interface 1600 allows a user 1542 to consolidate suppliers 1639. The user 1542 adds other synergies 1630 and risks 1650 and sub-deliverables 1680 to the panel 1616 via links 1638, 1689.

The interface 1600 can also present a general status indicator 1613 and a due date 1614. Another panel 1640 shows recent news, emails 1643, checklists 1641, and objects 1642. Additionally, a panel 1660 shows one or more personalized tasks 1661.

Another panel 1601 in the interface 1600 presents a user 1542 with access to several other views, including a file space view 1603, a methodology view 1604, a view of research and reports 1605, and a view of a merger log 1606. The panel 1601 includes a link (not shown) to access human resource-related synergy tools. The panel 1601 can also have search capabilities 1607 and links to a number 1609 of actions 1608. Moreover, a user 1542 can contact a number 1612 of other team members 1611.

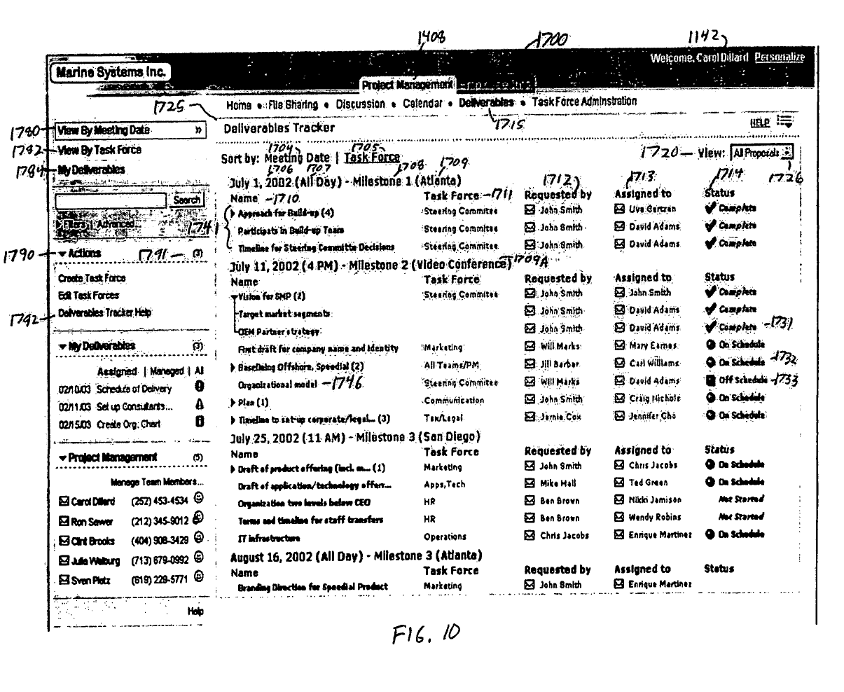

FIG. 10 presents an exemplary interface 1700 with a panel 1725 for a deliverables tracker tool. The panel 1725 can be presented from a deliverables view 1715 in the project management menu 1408. The interface 1700 allows a user to select a presentation of one or more deliverables in the deliverables tracker panel 1725 by meeting date 1704, 1780 or by a task force 1705, 1782. The interface 1700 presents personalized deliverables 1784. The panel 1725 shows a deliverables view 1720 by items in a pull down menu 1726. When deliverables are presented in the panel 1725 by meeting dates 1704, the panel shows a list 1741 of deliverables for each date 1706. For each date 1706, the panel 1725 presents a time 1707, a restructuring goal or milestone 1708, and a location 1709. The location 1709 refers to a physical location for a meeting or a physical location for a restructuring division or group addressing the deliverable.

Each deliverable presented in the list 1741 has an associated name 1710, task force 1711, requestor 1712, assignee 1713, and status 1714. The status 1714 indicates if a deliverable 1746 is on schedule 1732, off schedule 1733, or is complete 1731. The interface 1700 presents a number 1791 of actions 1790, such as a link 1792 to access a deliverables tracker help or reference session.

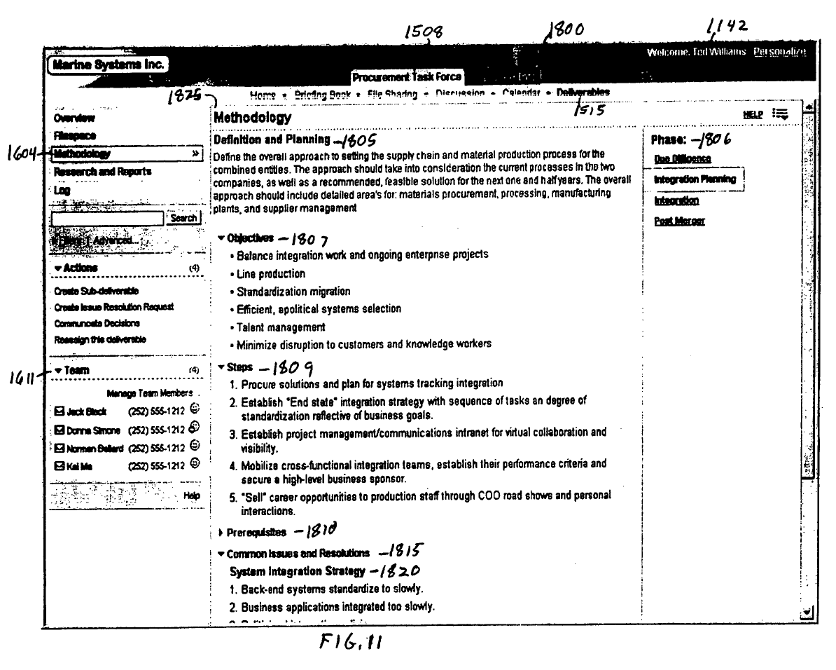

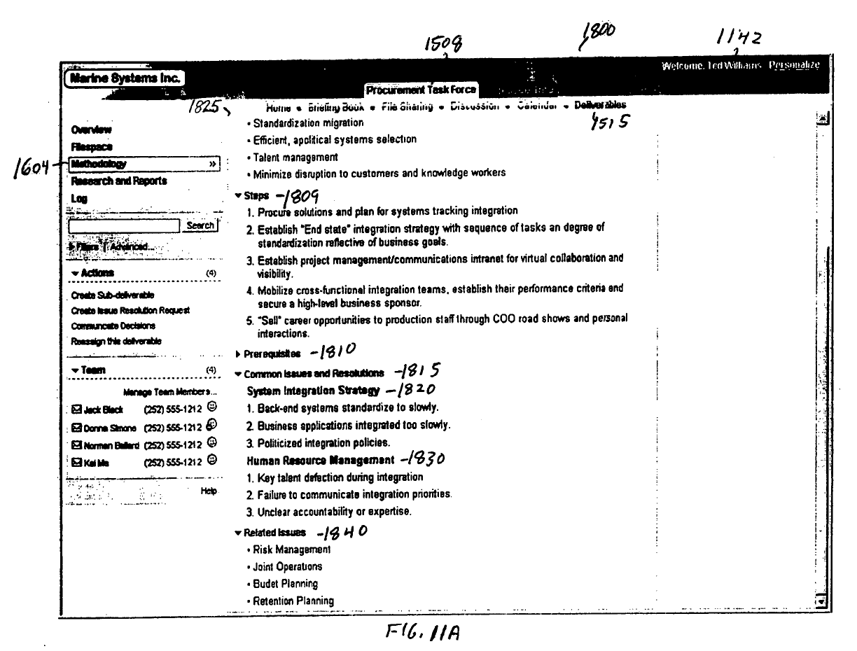

FIG. 11 presents an exemplary interface 1800 for a methodology roadmap 1604 for deliverables 1515 for the procurement task force 1508. The interface 1800 includes a methodology panel 1825 for one or more restructuring phases 1806. A deliverable room reference model can include the methodology panel 1825. The panel 1825 shows a detailed definition and planning 1805. The panel 1800 allows stakeholders 1611 to view and learn overall restructuring strategies and objectives, and to collaborate and implement restructuring actions. The panel 1825 presents objectives 1807, restructuring steps 1809, prerequisites 1810, and issues and resolutions 1815. As shown in FIG. 11A, the panel 1825 shows issues and resolutions, such as system integration strategy 1820, human resource management 1830, and other related issues 1840.

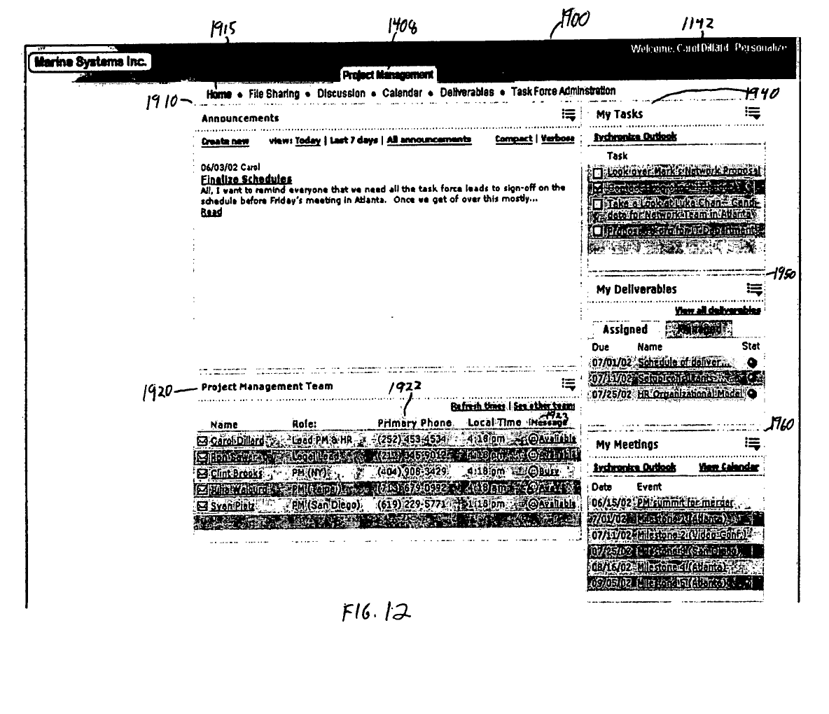

FIG. 12 illustrates an exemplary home page interface 1900 for a stakeholder 1142 in the project management team 1408. The interface 1900 can be personalized for the stakeholder 1142 and greet the stakeholder 1142 with an announcement panel 1910. The stakeholder 1142 can view a panel 1920 of a project management team, along with contact information 1922 and availability 1923 of team members. The interface 1900 has personalized panels for tasks 1940, deliverables 1950, and meetings 1960.

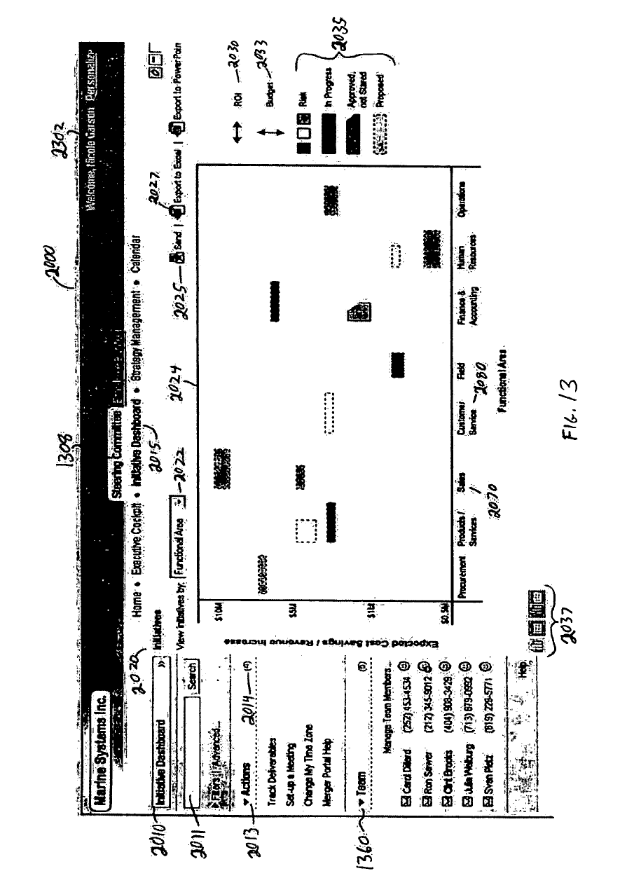

FIG. 13 illustrates an interface 2000 for an initiative dashboard 2015 in a steering committee menu 2308. An initiative dashboard panel 2020 allows a user to view a graph 2024 of initiatives. A selector 2022 shows an initiative graph 2024 by functional area, cost savings, revenue increase, or other initiative options. The panel 2020 shows a graph legend 2035 with different types and statuses of restructuring information. The graph 2024 presents restructuring financial information for a functional area, such as a return on investment 2030 or a budget 2033.

A user 2302 can send 2025 the initiative information, such as graph 2024, to other stakeholders or transfer the information to an external software object, such as an Excel® spreadsheet 2027 by Microsoft Corporation.

The interface 2000 allows a user to access a graph 2024, a list, or a graph and a list of initiative information via icons 2037. Furthermore, the interface 2000 can have a panel 2010 with a text box 2011 to allow the user 2302 to search for items or people, as well as to perform a number 2014 of other actions 2013.

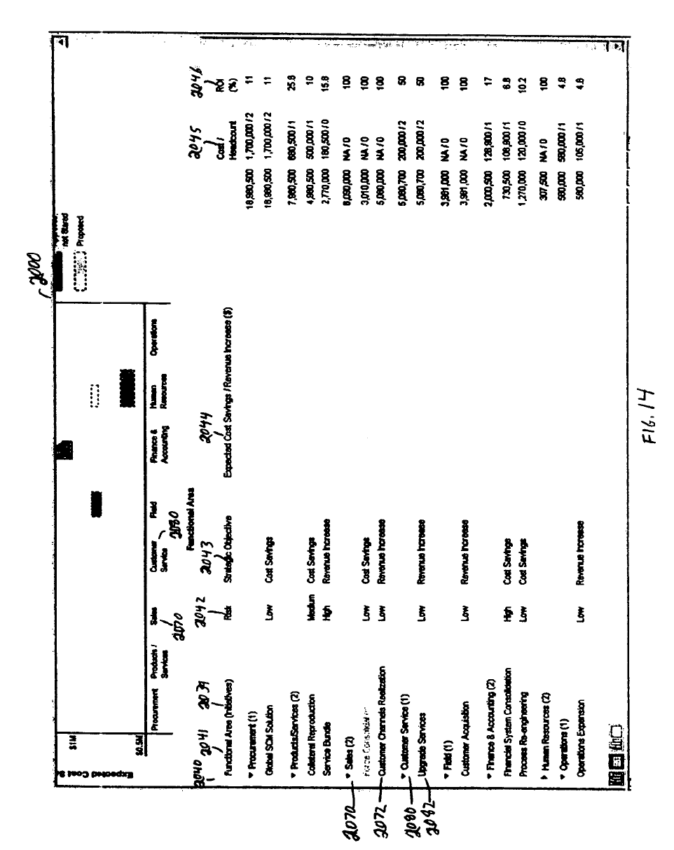

The interface 2000 includes a panel 2040 (of FIG. 14) that presents information from the initiative graph 2024 in a list or table format. The panel 2040 presents a functional area 2041 for a number 2039 of initiatives. An initiative risk level 2042, a strategic objective 2043, and an expected cost savings 2044 can be presented. Additionally, a return on investment 2046 and a cost per headcount 2045 is shown for listed initiatives.

The panel 2040 presents one or more sales and customer service initiatives 2070, 2080 as shown in the graph 2024. The sales initiative 2070 includes a realization of customer channels 2072. The customer service initiative 2080 includes upgrading services 2082.

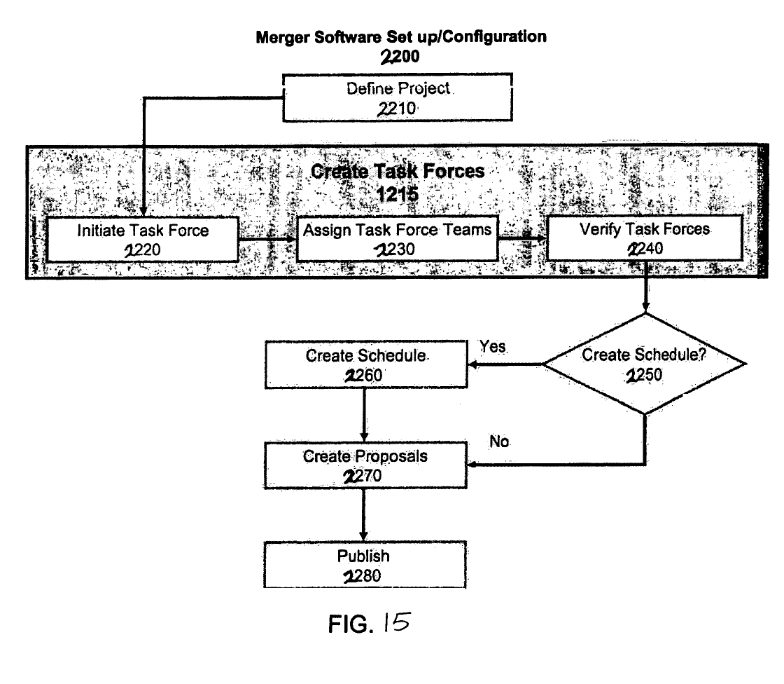

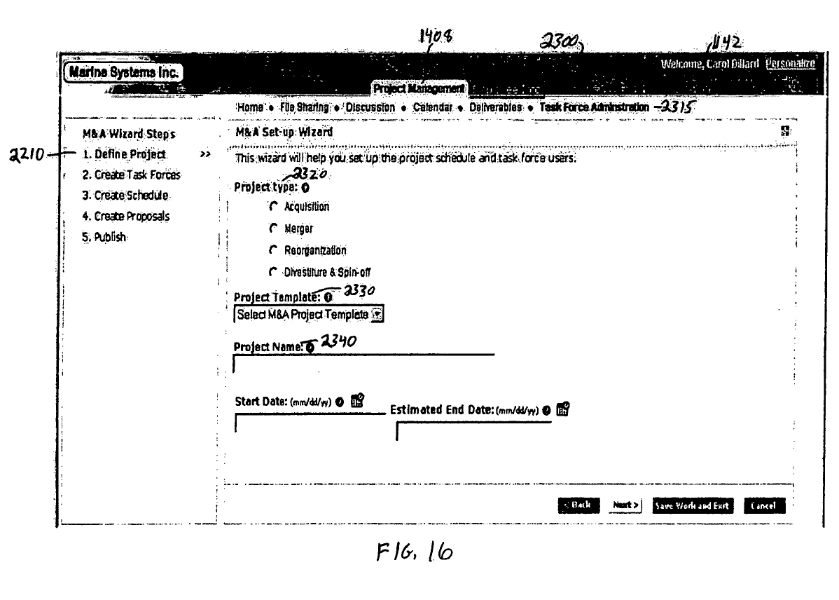

FIG. 15 depicts a flow diagram of an exemplary stakeholder set up 2200 that allows a user to define the project 2210, as illustrated in FIGS. 15 and 16. The interface 2300 in FIG. 16 allows a user to define a project by type 2320 or select a predefined project template 2330. Additionally, a project name 2340 can be entered in the interface 2300.

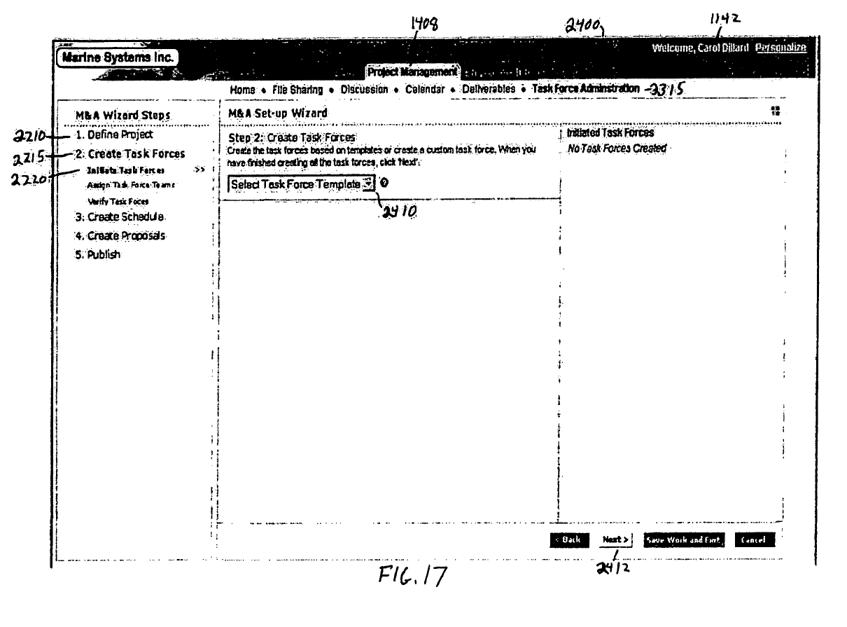

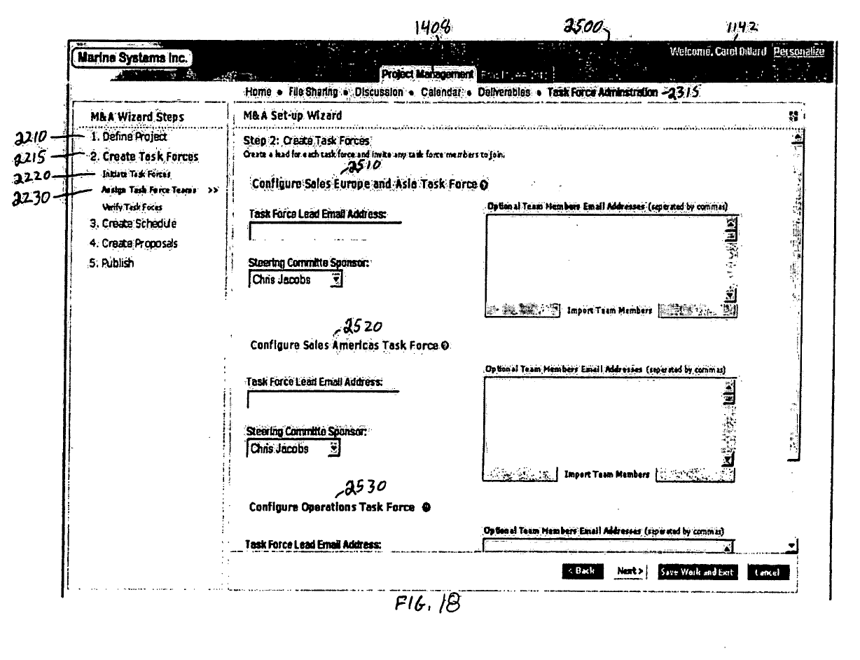

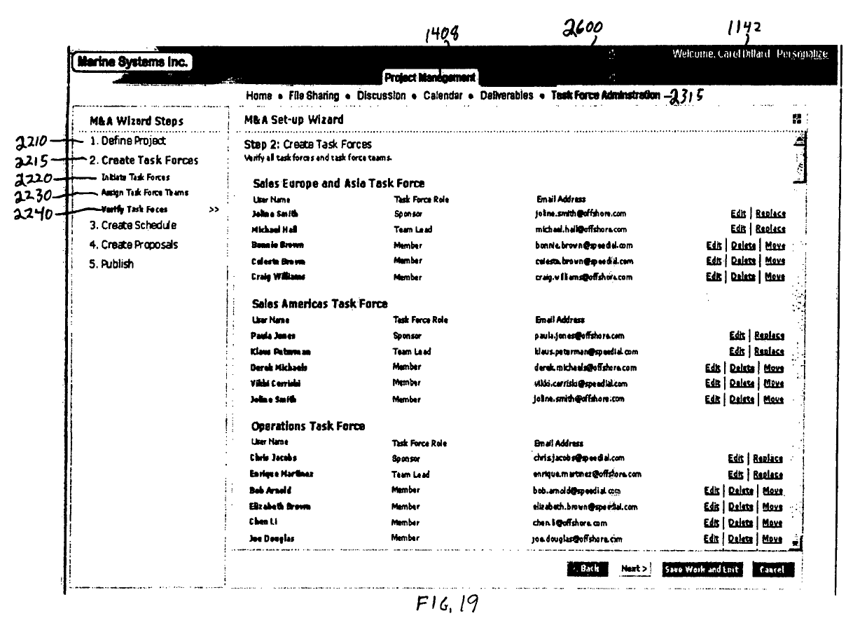

A task force can be initiated 2220 with a template 2410 and a “next” button 2412, as shown 2410 in FIG. 17. The tool 2200 allows the user to assign stakeholders to task force teams 2230 in FIGS. 15 and 18. As illustrated in FIG. 18, stakeholders can be assigned to one or more sales teams 2510 and 2520. Moreover, other task force teams, such as the operations task force 2530, can be configured in the user interface 2500. After the members of the task force teams have been assigned, the task force team assignments are verified 2240 in FIGS. 16 and 19. FIG. 19 illustrates an interface 2600 to verify task forces.

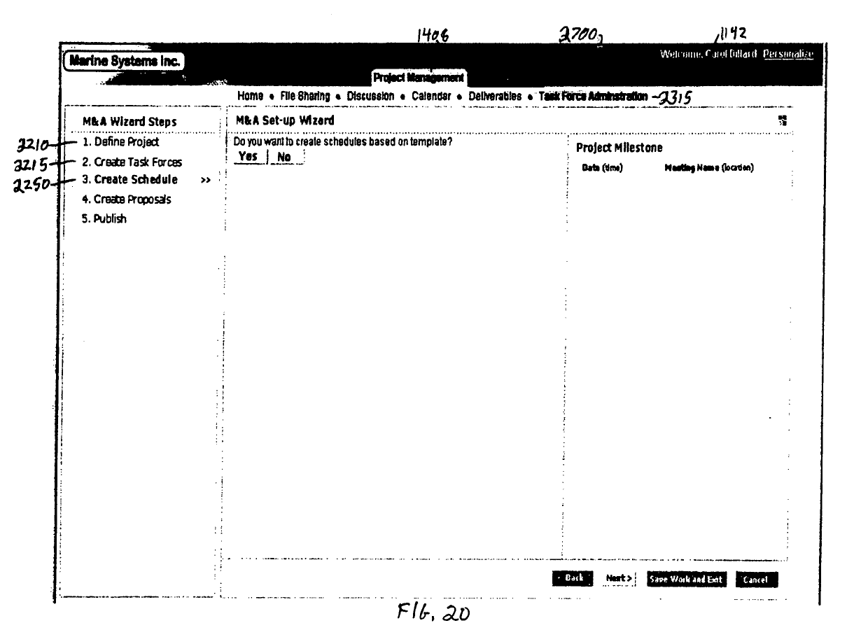

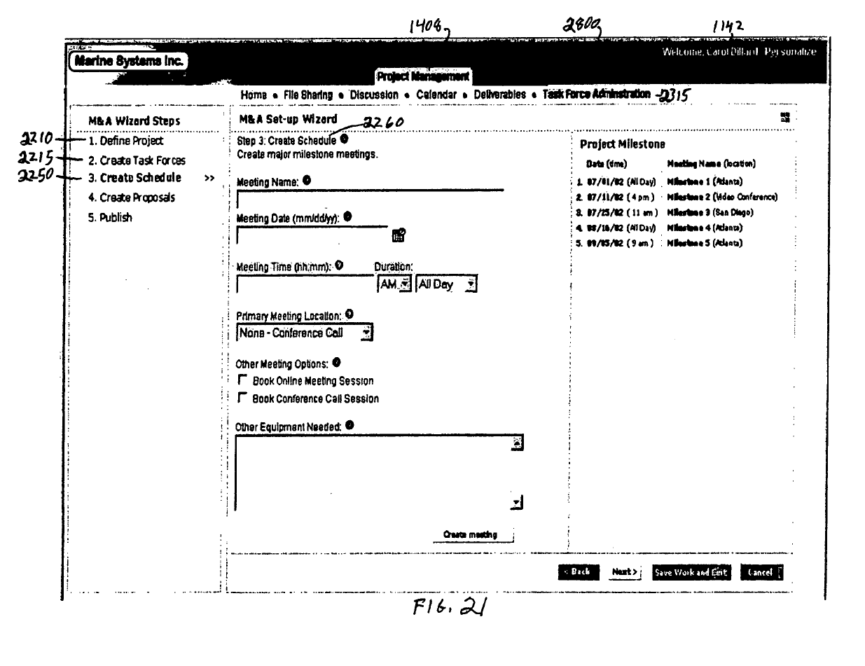

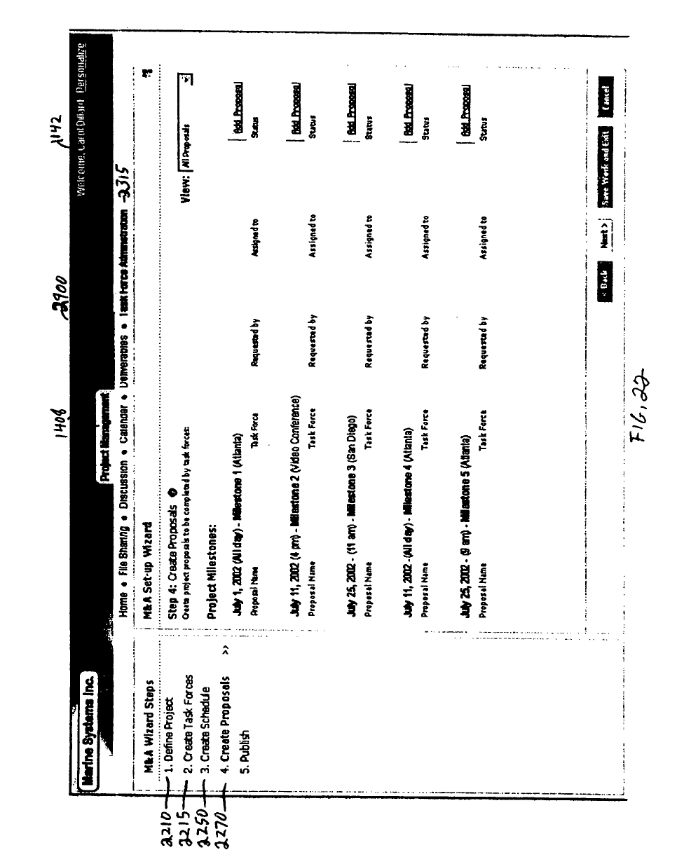

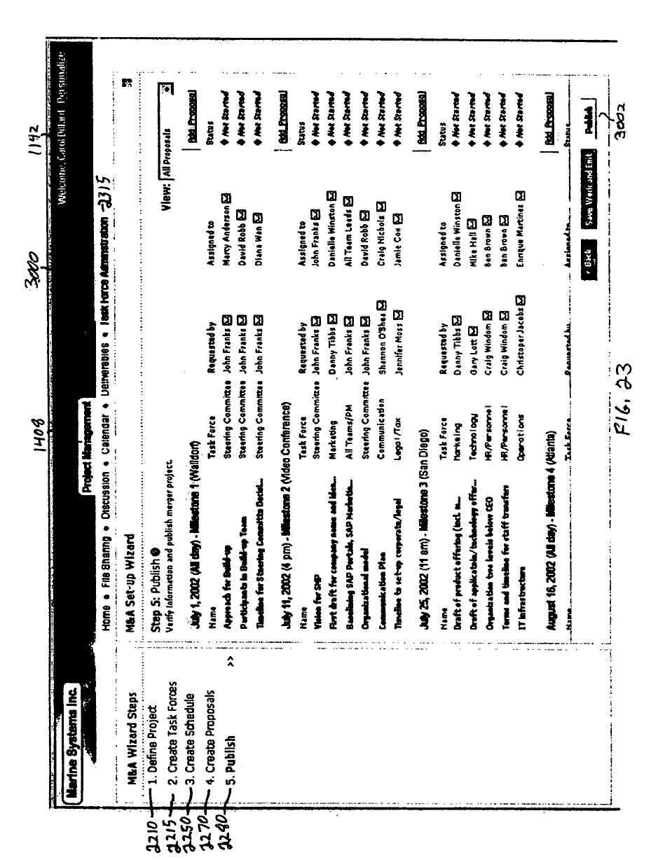

A schedule 2250 in interface 2700 is shown in FIG. 20. FIG. 21 illustrates a generated schedule interface 2800. If the schedule is not generated, then proposals 2270 (FIG. 16 and 22) are generated. Otherwise, if a schedule is generated as shown in 2800, then proposals are generated for the next configuration block 2270 in FIG. 16. FIG. 22 shows an exemplary proposal interface 2900. After one or more proposals are generated, then the restructuring project information is published 2280 via a “publish” button 2002 in interface 2000 in FIG. 23.

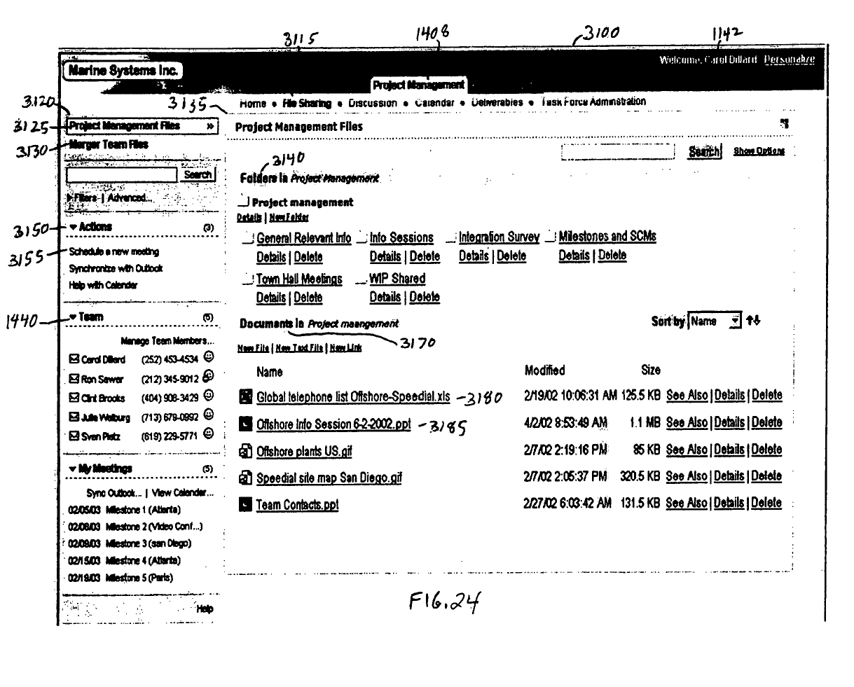

FIG. 24 illustrates an interface 3100 that allows stakeholders from various groups to collaborate, communicate, and share information during the restructuring. In particular, FIG. 24 shows an interface 3100 for a stakeholder 1142 in the project management team. The project management tab 1408 presents the stakeholder 1142 with a menu of views, including a view 3115 for sharing objects with stakeholders in the project management team. The interface 3100 facilitates collaboration by presenting a view 3135 for the project management stakeholders to share folders 3140 and documents 3170. Some of the shared documents can be external objects 3180, 3185.

The stakeholder 1142 in the project management team also can share objects with stakeholders in a merger team 3130. Additionally, the stakeholder 1142 can view and access other project management team members 1440 and initiate merger actions 3150, such as scheduling a new meeting 3155.

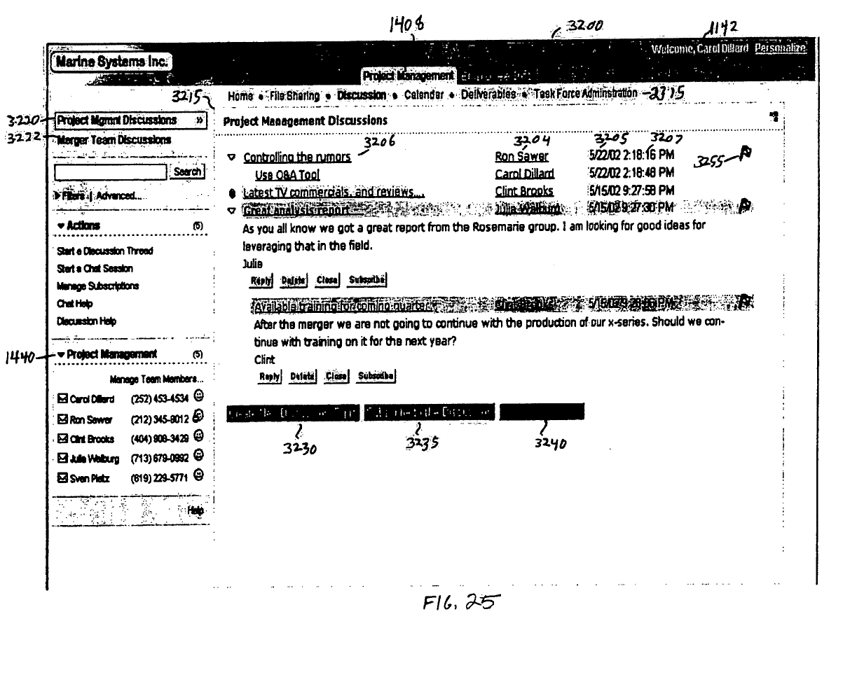

FIG. 25 illustrates an exemplary interface 3200 with a panel 3215 for communication management and group discussions. The interface user 1142 can access a restructuring issue 3206 posted by a member 3204 of a team 1440. The interface 3200 shows a time 3207 and date 3205 of the posting of the issue 3206. A flag or follow-up indicator 3255 signifies that the issue 3206 should be resolved quickly. The team member 1142 begins a new discussion 3230, subscribes to a discussion 3235, or deletes a discussion 3240 from the panel 3215.

The interface 3200 also provides collaborative discussions between members of different restructuring groups. For example, the user interface 3200 can be accessed by members from a restructuring team 3222, in addition to the project management team 3220.

Other embodiments may be within the scope of the following claims.

What is claimed is:

1. A method comprising:
providing a single logical physically distributed information system across one or more information systems of at least two enterprises, the enterprises are being combined; and
providing a user interface to access the single logical physically distributed information system to manage one or more restructuring-related issues, the user interface is adapted to manage one or more deliverables associated with a restructuring.

2. The method of claim 1 further comprising:
providing a user interface to integrate restructuring-related projects and resources for at least one enterprise;
providing a user interface to implement restructuring-related projects and resources for at least one enterprise; and
providing a user interface to manage training, planning, and communication activities.

3. The method of claim 2 further comprising providing a user interface to use the single logical physically distributed information system to execute at least one of pre-restructuring and post-restructuring activities, the post-restructuring activities comprising a post-restructuring assessment and a measurement of one or more achieved synergies.

4. The method of claim 3 further comprising providing one or more user interfaces are adapted to a role of the user and a phase of the restructuring, a security of the one or more user interfaces being related to the role of the user and the phase of the restructuring, the role of the user comprising an executive role.

5. An article comprising a machine-readable medium storing instructions operable to cause a machine to perform operations comprising:
providing an interface for a user to monitor a progress of a merger of at least two organizations;
managing merger-related communications of at least one of the organizations;
tracking one or more merger-related deliverables; and
managing one or more merger-related deliverables of at least one of the organizations.

6. The article of claim 5, wherein the operations further comprise:
providing a virtual project room adapted for one or more executives of at least one of the organizations; and
providing a common collaborative environment adapted for a plurality of merger members.

7. A system for planning a merger of at least two organizations, the system comprising a software product, wherein the software product comprises a module adapted to allow a user to manage one or more merger-related projects for at least one of the organizations, wherein the module comprises one or more sub-modules adapted to allow a user to address a plurality of merger-related issues wherein the sub-modules comprise at least one of an executive cockpit sub-module, a training management sub-module, a deliverables management sub-module, a project planning sub-module, and a communications management sub-module, wherein the deliverables management sub-module comprises a deliverable room sub-module and a deliverable tracker sub-module, wherein the executive cockpit sub-module is adapted to provide a view of a merger integration progress for one or more executive stakeholders.

8. The system of claim 7, wherein the training management sub-module serves as a repository to request, schedule, and monitor an execution of one or more training sessions, and the training management sub-module further provides a platform to facilitate one or more training processes.

9. The system of claim 7, wherein the training management sub-module comprises at least one of a training class repository, a master training scheduler, an electronic mailing service for training invitations, and an archive of on-line training, and the master training scheduler comprises at least one of a department-specific scheduling service, a department-specific planning service, a role-specific scheduling service, and a role-specific scheduling service.

10. The system of claim 9, wherein the training management sub-module is adapted to track a completion of training for one or more stakeholders, training topics, and organizational locations, and the training management sub-module is further adapted to report a completion of training for one or more stakeholders, training topics, and organizational locations to a user.

11. A system for managing a merger of at least two organizations, the system comprising a portal, an object modeling tool, and a computer module adapted to allow a user to monitor one or more tasks associated with a synergy achievement, the computer module comprising a deliverable room.

12. The system of claim 11, the deliverable room comprising a sub-deliverable room, wherein the sub-deliverable room comprises one or more characteristics from the deliverable room, wherein the one or more characteristics comprise security permissions, and the computer module is further adapted to generate and assign one or more tasks associated with the synergy achievement.

13. A system for managing a merger of at least two organizations, the system comprising a computer product comprising a deliverable room adapted for one or more merger stakeholder users, wherein the one or more stakeholder users comprise an executive of at least one of the organizations.

14. The system of claim 15, wherein the computer product comprises one or more interfaces adapted to present merger-related information including, at least one of a team roster, a task list, a shared folder, a meeting scheduler, a note from a meeting, an issue list, a decision list, and a status.

15. The system of claim 13, wherein the deliverable room comprises a hierarchal parent room of one or more sub-deliverable rooms, wherein the deliverable room comprises a reference model, and the reference module comprises pre-populated data.

16. The system of claim 15, wherein the deliverable room further comprises at least one of a methodology, a help tool, and a set of contextual tools adapted for a specific deliverable, wherein the specific deliverable comprises a realignment of compensation for employees.

17. An article comprising a machine-readable medium storing instructions operable to cause a machine to perform operations comprising:
providing one or more user interfaces for a merger of at least two organizations; and
enabling a plurality of project management capabilities for the one or more user interfaces, wherein the project management capabilities comprise:
managing a timeline of a merger project;
setting at least one of a milestone meeting, deliverable, due date, and owner; and
tracking a progress of the merger.

18. An article comprising a machine-readable medium storing instructions operable to cause a machine to perform operations comprising:
providing one or more user interfaces for a merger of at least two organizations; and
displaying at least one of a merger-related communication plan, a merger-related communication execution, and a merger-related communication monitoring for at least one of the organizations to an interface user.

19. The article of claim 18, wherein the operations further comprise:
sending an approval request to the interface user;
showing a merger progress in the interface;
updating the merger progress shown in the user interface; and
loading merger-related information from an user interface template.

20. The article of claim 18, wherein the operations further comprise:
informing one or more interface stakeholder users of a merger-related item, wherein the merger-related item comprises at least one of a new campaign, an event, a news item, a poll, a survey, a frequently asked question, a merger-related question and a corresponding response to the merger-related question, an assignment, a schedule reminder, a language translation request, a report, a status, a rollout, an archive, and a previous communication.

21. A system for managing a merger of at least two organizations, the system comprising a user interface adapted to allow a user to access, plan, and manage the merger, the interface presenting one or more performance indicators of an entity within one of the organizations.

22. The system of claim 21, wherein the interface further presents one or more merger issues in a decision box.

23. A system for managing a merger of at least two organizations, the system comprising a collaborative calendar interface, the calendar interface adapted to allow a plurality of stakeholders to view merger-related events and to facilitate training management.

24. The system of claim 23, wherein the collaborative calendar interface facilitates one or more rollout trainings and one or more scheduling of one or more services for the plurality of stakeholders, wherein the calendar interface comprises information relating to at least one of a stakeholder role and a merger group, wherein the calendar interface further adapted to allow an exchange of information with an external calendar tool.

25. A computer system for managing a merger of at least two organizations, the computer system comprising merger-related information and a user interface adapted to present one or more merger deliverables, wherein the user interface comprises a panel presenting one or more requested deliverables and one or more deliverables assigned to an interface user.

26. The computer system of claim 25, wherein the panel further presents at least one of a targeted merger task force, an initiating deliverable contact person, a deadline, and a status, the one or more merger deliverables comprising one or more merger sub-deliverables.

27. A system for managing a merger of at least two organizations, the system comprising a computer module, the computer module comprising a merger deliverables tracker tool and a user interface adapted to present one or more merger-related deliverables tracked with the tracker tool.

28. The system of claim 27, wherein the user interface is adapted to allow a stakeholder to select a view of one or more lists of deliverables by at least one of a meeting date and a task force, the interface adapted to present a deliverables tracker reference session link.

29. The system of claim 28, wherein the view of one or more lists comprises a meeting date, a time, a milestone, a location, and a deliverable information, the deliverable information comprising a name, a task force, a requester, an assignee, and a status.

30. A system comprising:
a plurality of restructuring-related interfaces for a restructuring of at least two organizations, the plurality of restructuring-related interfaces comprising one or more restructuring-related issues;
a plurality of user interface components adapted to interact with the plurality of restructuring-related interfaces; and
a layer of application logic services, the layer interacting with the plurality of restructuring-related interfaces, the application logic services related to the restructuring.
